(19) United States
(12) Patent Application Publication
(10) Pub. No.: US 2022/0309463 A1
(43) Pub. Date: Sep. 29, 2022

(54) SYSTEMS AND METHODS FOR TRADE PARTNER INFORMATION SHARING

(71) Applicant: Wells Fargo Bank, N.A., San Francisco, CA (US)

(72) Inventor: Matthew J. Heffron, Bishop, CA (US)

(21) Appl. No.: 15/432,646

(22) Filed: Feb. 14, 2017

(51) Int. Cl. G06Q 10/10; G06Q 40/04

(52) U.S. Cl. CPC G06Q 10/10; G06Q 40/04

(57) ABSTRACT

A system and method for managing participant information records (PIRs) includes receiving, by a processor of a participant computing system, a PIR generation request from a participant via a participant computing device. The PIR generation request includes a participant identity and business information. The method further includes generating a PIR for the participant, publishing the PIR to a PIR blockchain, determining a PIR update to the PIR, and publishing the PIR update to the PIR blockchain to reflect a change in the PIR.

### TECHNICAL FIELD

Embodiments of the present disclosure relate generally to the field of trade partner information sharing.

### BACKGROUND

A blockchain is a publicly viewable, append-only, distributed ledger having wide application in the financial services industry. A blockchain includes multiple blocks, each containing data and a hash of the previous block, thereby linking the blocks in the blockchain. Blockchain entries consist of blocks of information that can include transactions, transaction record components, transaction entities, and the like.

A trade partner is one of the two or more participants in an ongoing business relationship. Trade partners have agreed to trade certain items or information to one another. Trade partners must regularly update contact, financial, and tax information such that trade partners with which they have a business relationship are informed of the information for shipping, financial, and tax, including auditing, purposes.

### SUMMARY

A first example embodiment relates to a method of managing participant information records (PIRs). The method includes receiving, by a processor of a participant computing system, a PIR generation request from a participant via a participant computing device. The PIR generation request includes a participant identity and business information. The method further includes generating a PIR for the participant, publishing the PIR to a PIR blockchain, determining a PIR update to the PIR, and publishing the PIR update to the PIR blockchain to reflect a change in the PIR.

Another example embodiment relates to a PIR management system. The PIR management system includes a network interface configured to facilitate data transmission over a network and a PIR update circuit. The PIR update circuit is configured to generate a PIR for a participant of a PIR blockchain system and publish the PIR to a PIR blockchain. The PIR blockchain is managed by the PIR blockchain system. The PIR update circuit is further configured to determine a PIR update to the PIR and publish the PIR update to the PIR blockchain to reflect a change in the PIR.

These and other features, together with the organization and manner of operation thereof, will become apparent from the following detailed description when taken in conjunction with the accompanying drawings, wherein like elements have like numerals throughout the several drawings described below.

### BRIEF DESCRIPTION OF THE FIGURES

FIG. 1 is a schematic diagram of a PIR management system, according to an example embodiment.

FIG. 2 is a detailed schematic diagram of the PIR management system of FIG. 1, according to an example embodiment.

FIG. 3 is a flow diagram of interactions between a participant, a non-participant, and a granting institution in relation to the PIR management system of FIG. 1, according to an example embodiment.

FIG. 4 is a flow diagram of PIR generation and updates via blockchain, according to an example embodiment.

### DETAILED DESCRIPTION

Referring generally to the figures, systems and methods for trade partner information sharing via a blockchain-based system are shown. According to various example embodiments, a trade partner information sharing system allows for updates to a PIR for each trade partner on a blockchain-based system. When used herein, “PIR” refers to a compiling of information related to each trade partner and is essential to the successful completion of transactions occurring between trade partners. Information included in a PIR for a trade partner can include, but is not limited to, name, address, phone number, email, automated clearing house (ACH) routing number, wire routing number, account numbers, employer identification number (EIN), resale identification (ID), tax exemption ID, and minority status. The system allows trade partners (e.g., buyers and sellers) to a transaction to conduct up-to-date transactions using a blockchain, allowing for real-time updates of trade partner data, and thus, ensuring successful completion of transactions between trade partners.

The blockchain-based PIR management system solves technical problems associated with conventional data systems. Conventionally, when conducting transactions, a party entering into a transactional relationship with another party must supply all the information pertinent to the transaction and to successful maintenance of the transaction relationship. For example, each party to a transaction must provide basic information to the other party for the transaction to be successfully completed, such as names, addresses, phone numbers, tax documentation, and so on. In a conventional system, the parties must manually transmit information regarding any updates to this information. If not provided, it may be difficult for a party to locate particular information or any indication that information for the other party has changed. The tracking of information on the instant blockchain-based system results in transparency and increased trustworthiness of trade partner relationships. In particular, a trade partner's tax status is important for auditing purposes. Without current knowledge of a trade partner's tax status, parties entering into transactions with that trade partner can be relying on outdated tax information and could potentially submit false tax information. Additionally, by tracking updates of information on a blockchain-based system, parties can conduct more accurate, efficient, and secure transactions. According to various example embodiments, the instant blockchain-based system informs trade partners of important update information (e.g., location changes, name changes, tax status changes, etc.) without the need for the trade partner to seek out the information in various stored locations. Further, the instant blockchain-based system preserves the history of updated information. Unlike current systems in which updates to information may be scattered and unattainable by a trade partner or the updates simply replace the outdated entity information, the instant blockchain-based system publishes new information (e.g., updated address, tax status) in a new block without deleting other related information (e.g., prior address, prior tax status).

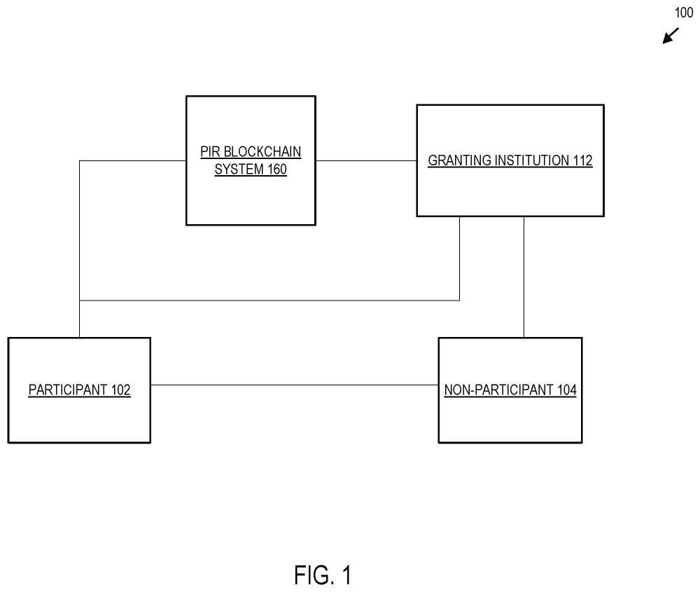

Referring to FIG. 1, a schematic diagram of a PIR management system 100 is shown, according to an example embodiment. As described in further detail below, the system 100 facilitates updates to PIRs for trade partners (e.g., participants 102) to a transaction using a PIR blockchain system 160. The PIR management system 100 includes at least one participant 102, a non-participant 104, and a granting institution 112.

The participant 102 is an entity (e.g., individual, company, organization, etc.) that has viewing and updating access to the PIR blockchain system 160. The participant 102 can view real-time updates of trade partner information on the PIR blockchain system 160 and can also publish updates to PIRs on the PIR blockchain system 160. As such, the participant 102 is conducting or desires to conduct a transaction with another participant 102 and/or non-participant 104, while utilizing the PIR blockchain system 160. For example, the participant 102 may be a party selling or buying goods from another participant 102 and/or non-participant 104. Prior to being a participant 102 and having access to the PIR blockchain system 160, an entity is designated as a non-participant 104 without access. To become a participant 102, the entity either receives an offer to share from an existing participant 102 or the entity generates an access request to be validated by the granting institution 112. Once the granting institution 112 verifies the identity of the entity, an access block can be published by the granting institution 112 to the blockchain to be later accessed by a participant 102 for authentication of another participant 102.

The non-participant 104 is an entity (e.g., individual, company, organization, etc.) that does not have viewing and updating access to the PIR blockchain system 160. In some embodiments, the non-participant 104 receives an offer to share from a participant 102 (e.g., a trade partner of the non-participant 104) to view updates of information of the participant 102 on the PIR blockchain system 160. The non-participant 104 can additionally request access to the PIR blockchain system 160 without receiving an offer to share from an existing participant 102, which is then relayed to the granting institution 112 for identity verification.

The granting institution 112 is a trusted third party of the relationship between participants 102 (e.g., trade partners) and/or between a participant 102 and a non-participant 104. In some embodiments, the granting institution 112 receives an access request for a non-participant 104, verifies the identity of the non-participant 104, and grants access to the PIR blockchain system 160. The granting institution 112 then publishes an access block for the newly established participant 102 to the blockchain, as described in more detail below. The granting institution 112 may additionally update the status of the access of the participant 102 if the access is later revoked by adding subsequent blocks to the blockchain, as described further herein.

The following is an example of granting access to a non-participant 104 to the PIR blockchain system 160. A non-participant 104 and participant 102 are conducting business transactions as the buyer and seller of goods, respectively. The system 100 allows the participant 102 to generate and transmit an offer to share trade partner data (via the PIR blockchain system 160) to the non-participant 104. When referred to herein, an “offer to share” includes a message sent to a non-participant (e.g., an entity without access to the blockchain system 160) from a participant (e.g., an entity with access to the blockchain system 160) that invites the non-participant 104 to be granted access to view information related to the participant that is updated and published to the blockchain system 160. Upon receipt of the offer to share, the non-participant 104 may accept the offer, at which time, the participant 102 transmits a vetting request message to the granting institution 112 to perform a vetting process of the non-participant 104. The granting institution 112 performs the vetting process and upon approval of the non-participant 104, publishes an access block to the blockchain system 160 for the non-participant 104. Simultaneous to the publishing of the access block, the granting institution 112 informs the participant 102 and the non-participant 104 of the approval. At this point in time, the non-participant 104 becomes a participant 102 of the PIR blockchain system 160. Using the PIR blockchain system 160, each participant 102 can update information on their own PIR blockchain and can view trade partner information on each other's PIR blockchains. As described further herein, in some embodiments, a transaction blockchain is established as a parallel or shadow blockchain that is associated with both participants 102 (e.g., with each trade partner to a transaction relationship).

Management of the PIR blockchain system 160 occurs throughout the existence of the transaction relationship between participants 102. The granting institution 112 can publish an access block for a participant 102 and the participant 102 (via the participant computing system 106, can publish updates to the PIR within the PIR blockchain system 160, as described further herein. Additionally, any revocations of access to the blockchain system 160 can be published to the blockchain system 160 and be made available such that other participants 102 that may be involved in the transaction relationship can view such information.

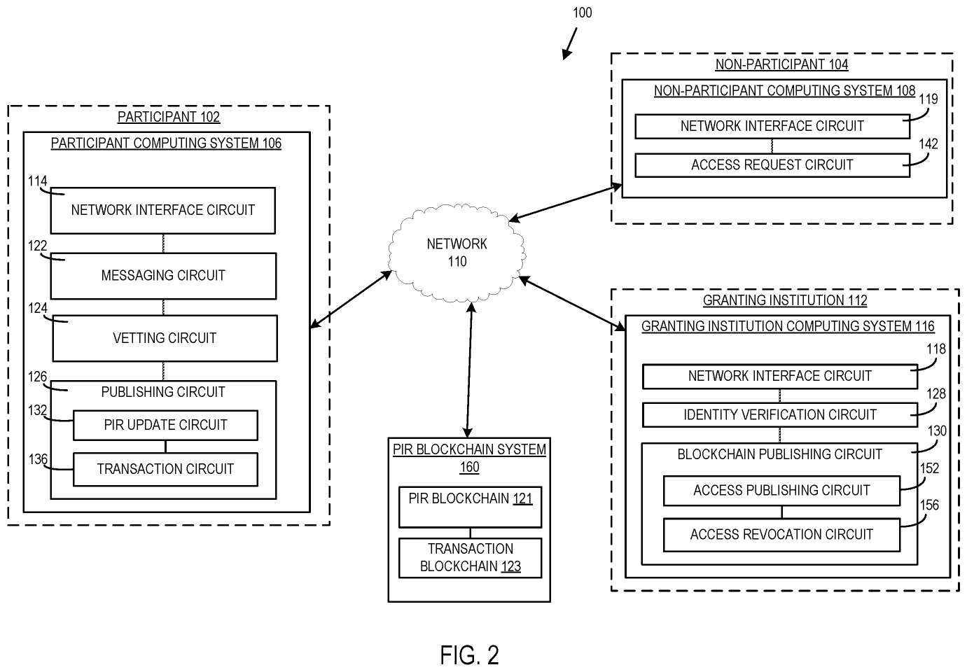

Referring to FIG. 2, the system 100 facilitates updates of PIRs to the PIR blockchain system 160 by participants 102. Additionally, the system 100 facilitates granting of access to non-participants 104 of the PIR blockchain system 160 by the granting institution 112. As shown, the system 100 includes a participant computing system 106 communicably and operatively coupled to each of a non-participant computing system 108 associated with a non-participant 104, a PIR blockchain system 160, and a granting institution computing system 116 associated with a granting institution 112, over a network 110. The network 110 provides communicable and operative coupling between the granting institution computing system 116, participant computing system 106, non-participant computing system 108, the PIR blockchain system 160, and the other components disclosed and described herein to provide and facilitate the exchange of communications (e.g., data, instructions, values, commands, etc.). Accordingly, the network 110 may include, for example, the Internet, cellular networks, proprietary cloud networks, and the like.

The PIR management system 100 allows management of privately viewable blockchain entries pertaining to updates of PIRs for participants 102 as part of a transaction relationship between trade partners. The PIR blockchain system 160, described further herein, includes a distributed permission-based blockchain system, where members are authorized to participate. Other embodiments include a permissionless blockchain system in addition to, or instead of, the permission-based blockchain system. For example, for a permissionless blockchain system, an entity does not have to be recognized as having a previous relationship with the system (e.g., public blockchain systems, Bitcoin, etc.), whereas for a permission-based blockchain system, the entity must be recognized as having a previous relationship with the system (e.g., private blockchain systems, private FI systems). For example, in a permission-based blockchain system, an entity desiring to utilize the system 100 must first be recognized and authorized to partake in the system.

The PIR blockchain system 160 may include PIRs of the participants 102. The PIRs and information relating to the updates of PIRs, such as changes in name, address, tax IDs, etc., are logged in the PIR blockchain system 160. In some embodiments, uniform resource identifiers (URIs) are stored on the PIR blockchain system 160. The URIs, for example, may point to a location from which the underlying information may be retrieved. For example, in some embodiments, URIs include uniform resource locators (URLs) of webpages from which the underlying data may be retrieved. In some embodiments, a combination of underlying data (e.g., PIR updates) and URIs (e.g., URLs pointing to PIRs) are stored on the PIR blockchain system 160. In some embodiments, the size of the PIR blockchain system 160 is prevented from getting excessively large by storing URIs on the PIR blockchain system 160 rather than the underlying data.

The PIR blockchain system 160 is communicably and operatively coupled to both the granting institution computing system 116 and the participant computing system 106 such that access to the system 160 is available to both the granting institution 112 and the participant 102. As noted above, the PIR blockchain system 160 may comprise a distributed permission-based blockchain system, where members are authorized to participate. Other embodiments include a permissionless blockchain system in addition to, or instead of, the permission-based blockchain system. In some embodiments, the PIR blockchain system 160 facilitates cross-referencing of two or more blockchains existing within the blockchain system 160. Multiple blockchains (e.g., PIR blockchains, transaction blockchains) can be cross-referenced based on participant 102 or transaction relationship (identifying two or more participants 102 as trade partners). For example, each participant 102 may have a separate blockchain including a PIR for that participant 102, and each participant 102 may be a trade partner with another participant 102 such that a transaction blockchain (e.g., including transaction information, PIRs for each participant 102, access information, etc.) for that relationship is cross-referenced to PIR blockchains for each participant 102.

The PIR blockchain system 160 includes a PIR blockchain 121 and a transaction blockchain 123. In some embodiments, the transaction blockchain 123 can be part of the PIR blockchain 121, such that the information pertaining to transactions involving the participant 102 is stored on the participant's separate PIR blockchain 121. The PIR blockchain system 160 is structured to store a plurality of PIRs, updates to PIRs, participant access information, revocation of access, trade partner agreements, transaction information, etc., on the PIR and transaction blockchains 121, 123. In particular, the PIR blockchain 121 includes a listing of PIRs and updates to PIRs of various participants 102. Some embodiments include multiple PIR blockchains 121. For example, in some embodiments, a separate (e.g., parallel, shadow, etc.) PIR blockchain 121 is created for PIRs relating to each participant 102. In some embodiments, a separate PIR blockchain 121 is created for PIRs relating to specific business markets (e.g., industrial, professional services, financial services, government, etc.).

The transaction blockchain 123 includes a listing of information related to trade partners to a transaction and/or the transactions taking place between trade partners. The transaction blockchain 123 can include (or be associated with) the PIRs of each trade partner. As such, the PIR blockchain 121 can be associated (e.g., linked) to the transaction blockchain 123 and can supply updates to the transaction blockchain 123 when a PIR update is published to the PIR blockchain 121. In some arrangements, the PIR blockchain 121 instructs the transaction blockchain 123 to update the related PIR information in the transaction blockchain 123 without communication with any external computing system. In other arrangements, as described below, the PIR blockchain 121 communicates with the participant computing system 102 to update the transaction blockchain 123 as necessary. The transaction blockchain 123 further includes trade party agreements, updates to trade party agreements, and business practices of each participant 102 (e.g., party to the trade partner relationship). The transaction blockchain 123 can additionally include a listing of each transaction that takes place during the trade partner relationship. The transaction blockchain 123 is maintained separately from the PIR blockchain 121 such that a participant 102 or permissioned third party may review PIRs, updates to PIRs, transactions, trade partner agreements, etc. without sifting through the PIR blockchain 121.

The participant computing system 106 is associated with or operated by the participant 102 (e.g., individual, company, organization, etc.). The participant computing system 106 may include any type of computing system including, but not limited to, a phone (e.g., smartphone, etc.) and a computing device (e.g., tablet computer, laptop computer, desktop computer, personal digital assistant, etc.). The participant computing system 106 is communicably and operatively coupled to the non-participant computing system 108 and the granting institution computing system 116 to facilitate interaction between the participant 102, non-participant 104, and granting institution 112. Additionally, in some embodiments, the participant computing system 106 is communicably and operatively coupled to the PIR blockchain system 160 to facilitate management of PIRs on the blockchain. The participant computing system 106 includes a network interface circuit 114, a messaging circuit 122, a vetting circuit 124, and a publishing circuit 126.

The network interface circuit 114 is structured to facilitate operative communication between the participant computing system 106 and other systems and devices over the network 110. The participant computing system 106 may, for example, include one or more servers each with one or more processors configured to execute instructions stored in a memory, send and receive data stored in the memory, and perform other operations to implement the PIR services described herein associated with the processing modules, databases and processes shown.

The messaging circuit 122 is structured to send an offer to share message to the non-participant computing system 108 via the network 110. As such, the messaging circuit 122 is communicably and operatively coupled to the non-participant computing system 108. The messaging circuit 122 sends an offer to share message to the non-participant computing system 108 to establish communication between the participant 102 and the non-participant 104. The message can include a registration request for the non-participant 104 to register with the blockchain system 160 such that the non-participant 104 becomes a participant 102 of the system 160. The message can include identification of the participant 102 (e.g., PIR of the participant 102) such that the non-participant 104 can verify the identity of the participant 102 and trust that the offer to share is legitimate. Further, in some embodiments, the message can include a registration acceptance URL, which when accessed by the non-participant 104 can send an acceptance message to the participant computing system 106 via the network 110. The acceptance message sent to the participant 102 (via the participant computing system 106) indicates to the participant 102 that the non-participant 104 accepts the offer to share and agrees to register with the blockchain system 160. In some embodiments, the message can include a reference ID of the participant 102 indicating the transaction relationship for which the participant 102 wishes to share PIRs with the non-participant 104. The reference ID may also include a transaction ID referring to the trade partner relationship and/or transactions between the participant 102 and non-participant 104.

In some embodiments, the messaging circuit 122 is additionally structured to receive a request for access from the non-participant computing system 108. As described further herein, instead of transmitting an offer to share message as described above, an access request may originate from the non-participant computing system 108 and be received by the participant computing system 106. The access request circuit 142 of the non-participant computing system 108 generates and transmits an access request from the non-participant 104 to register with the blockchain system 160. The messaging circuit 122 receives the access request and communicates the request to the vetting circuit 124, which in turn, generates and transmits a vetting request to the granting institution computing system 116.

The vetting circuit 124 is structured to generate and transmit a vetting request to the granting institution computing system 116. Accordingly, the vetting circuit 124 is communicably and operatively coupled to the granting institution computing system 116 to transmit the message. The vetting circuit 124 generates the vetting request including identity information of a non-participant 104 the participant 102 desires to vet with the granting institution 112. The vetting request can include, but is not limited to, a name, address, phone number, email, tax IDs, EINs, etc. of the non-participant 104 such that the granting institution 112 can verify and vet the non-participant 104 for purposes of granting access to the blockchain system 160. In some arrangements, the vetting request can additionally include a message detailing whether the vetting request is stemming from an offer to share initiated by the participant 102 or from an access request from the non-participant 104. In this arrangement, the granting institution uses this message to determine when to publish an access block to the PIR blockchain system 160. As described further herein, the granting institution 112 may immediately publish the access block to the PIR blockchain system 160, thereby establishing a PIR blockchain 121 for the new participant 102 upon approval, if the granting institution 112 receives a message indicating the request for access was initiated by the non-participant 104. Furthermore, if the granting institution 112 receives a message indicating that the vetting request stems from an offer to share initiated by the participant 102, the granting institution 112 may wait until receiving an offer acceptance from the non-participant 104 to publish the access block to the blockchain system 160.

The participant computing system 106 includes a publishing circuit 126. The publishing circuit 126 is structured to receive PIR-related information (e.g., names, addresses, tax IDs, transaction IDs, etc.); determine whether the information should be published to the PIR or transaction blockchains 121, 123; determine what, if any, encryption should be used to process and protect the data; and ultimately publish the data to the correct blockchain in the correct format on the PIR blockchain system 160. The publishing circuit 126 receives information from the granting institution 112 (or another trusted third party) as revocations occur or as trade partner practices and agreements change. In other embodiments, the granting institution computing system 116 additionally, or alternatively, publishes this information to the blockchain system 160. The publishing circuit 126 includes a PIR update circuit 132 and a transaction information circuit 136.

The PIR update circuit 132 is structured to receive initial PIR generations and updates to PIRs from the participant computing system 106 and from other computing systems. The PIR update circuit 132 receives an initial PIR generation relating to a participant 102 and publishes the PIR to the PIR blockchain 121. The participant 102 enters the PIR into the participant computing system 106, which then uses the PIR update circuit 132 to publish the information to the PIR blockchain 121. The PIR update circuit 132 additionally receives updates to PIRs and publishes each update as a subsequent block on the PIR blockchain 121. As such, the PIR for the participant 102 is published initially on the blockchain and each update (e.g., address change, etc.) for the participant 102 is published in subsequent blocks such that the updates can be tracked throughout the existence of the PIR of a participant 102. In some arrangements, the PIR update circuit 132 is structured to generate and publish an access block for a non-participant 104 upon receiving approval from a vetting process conducted by the granting institution 112. As described further herein, in some arrangements, the granting institution 112 publishes the initial access block on the PIR blockchain 121.

The transaction information circuit 136 is structured to receive transaction information and publish the transaction information to the transaction blockchain 123. The transaction information can include, but is not limited to, transaction IDs, participant PIRs, updates to the PIRs, etc. The transaction information circuit 136 is additionally structured to generate and link the PIR update information from the PIR blockchain 121 to related blocks on the transaction blockchain 123 (e.g., as a parallel or shadow blockchain). As such, when a PIR update is published as a block to the PIR blockchain 121, the system 160 may instruct the transaction information circuit 136 to publish the PIR update to an associated block on the transaction blockchain 123.

The non-participant computing system 108 may be associated with or operated by the non-participant 104 (e.g., an individual, company, organization, etc.). The non-participant computing system 108 may be communicably and operatively coupled to the participant computing system 106 and the granting institution 112 to facilitate communication regarding registration of the non-participant 104 with the PIR blockchain system 160 via the participant 102 and/or the granting institution 112. The non-participant computing system 108 includes a network interface 119 and access request circuit 142.

The network interface 119 is structured to facilitate operative communication between the non-participant computing system 108 and other systems and devices over the network 110. The non-participant computing system 108 may, for example, include one or more servers each with one or more processors configured to execute instructions stored in a memory, send and receive data stored in the memory, and perform other operations to implement the PIR services described herein associated with the processing modules, databases and processes shown.

The access request circuit 142 is structured to generate and transmit an access request to the participant 102 via the network 110. In some embodiments, the access request circuit 142 generates a request including information about the non-participant 104 such that the participant 102 can verify the identity of and complete a vetting process of the non-participant 104. As noted above, the participant 102 can complete the vetting process via the granting institution 112. The access request circuit 142 then transmits the access request, including any necessary information, to the messaging circuit 122 of the participant computing system 106. The access request circuit 142 is thus communicably and operatively coupled to the messaging circuit 122 of the participant computing system 106 to transmit the access request to the participant 102. In additional or alternative arrangements, the access request circuit 142 may be communicably and operatively coupled to the granting institution computing system 116 such that the access request may be sent directly to the granting institution 112 to complete the identity verification and vetting process of the non-participant 104.

The access request circuit 142 may additionally be configured to receive an approval of access from the participant computing system 106 and/or the granting institution computing system 116. In various embodiments, upon approval of the non-participant 104 to register with the blockchain system 160, the participant computing system 106 and/or the granting institution computing system 116 communicates the approval of access to the access request circuit 142.

The granting institution computing system 116 is associated with or operated by the granting institution 112. The granting institution computing system 116 includes a network interface 118, an identity verification circuit 128, and a blockchain publishing circuit 130. The network interface 118 is structured to facilitate operative communication between the granting institution computing system 116 and other systems and devices over the network 110. The granting institution computing system 116 may, for example, include one or more servers each with one or more processors configured to execute instructions stored in a memory, send and receive data stored in the memory, and perform other operations to implement the PIR services described herein associated with the processing modules, databases and processes shown.

The identity verification circuit 128 is structured to verify the identity of a non-participant requesting access to the PIR blockchain system 160. To generate an approval for access and registration for the non-participant, the granting institution computing system 116 must first verify the identity of the non-participant 104 that is to be granted access to the blockchain system 160. To verify the identity of a user 102, the identity verification circuit 128 receives information from the non-participant computing system 108 and/or the participant computing system 106 regarding the identity of the non-participant 104. The identity verification circuit 128 checks that the non-participant 104 is associated with the participant 102 in regard to a trade partner relationship. To do this, the granting institution computing system 116 may receive an indication that the participant 102 has agreed to the access request of the non-participant 104 or has transmitted the access request as an intermediary of the non-participant 104 (e.g., the access request was first transmitted to the participant computing system 106 and then transmitted to the granting institution computing system 116 from the participant computing system 106). Then, the identity verification circuit 128 authenticates the identity of the non-participant 104 in accordance with the information received about the non-participant 104 included with the access request. Once the identity of the non-participant 104 has been verified and the non-participant 104 has been vetted, the identity verification circuit 128 communicates with the blockchain publishing circuit 130 to publish an access block to the PIR blockchain system 160 (e.g., to the PIR blockchain 121).

The blockchain publishing circuit 130 is structured to receive access approval information (e.g., registration of a non-participant 104 of the blockchain system 160), determine whether the information should be published to the PIR or transaction blockchains 121, 123, determine what, if any, encryption should be used to process and protect the data, and ultimately publish the data to the correct blockchain in the correct format on the PIR blockchain system 160. The blockchain publishing circuit 130 receives information from the granting institution computing system 116 as access requests are approved and/or as accesses are updated or revoked. The blockchain publishing circuit 130 includes an access publishing circuit 152 and an access revocation circuit 156.

In some arrangements, the blockchain publishing circuit 130 utilizes a digital signature schema to provide authentication, integrity, and non-repudiation to a future verifier. The digital signature schema could be used by one or more of the circuits that are included on the blockchain publishing circuit 130, for example the access publishing circuit 152 or the access revocation circuit 156. In those arrangements, the circuits within the blockchain publishing circuit 130 generate a messaging authentication code (MAC) using a specific symmetric cipher mode of operation called cipher block chaining. Alternatively, the circuits within the blockchain publishing circuit 130 could generate a keyed hash message authentication code (“HMAC”) that uses a hash algorithm instead of the symmetric cipher.

The access publishing circuit 152 is structured to receive an approval for access from an identity verification circuit 128. The access publishing circuit 152 is additionally structured to generate an access approval for a non-participant 104 and publish the access approval to the PIR blockchain 121 on the PIR blockchain system 160. The access approval includes the identity, a PIR, and the date and time of approval of the non-participant 104. In some arrangements, the access approval further includes a list of IDs of participants 102 the non-participant 104 is trade partners with. The access approval is published to the PIR blockchain 121 for access by the participant 102 that requested and/or approved of the registration of the non-participant 104 such that the participant 102 can confirm the non-participant 104 has registered with and is now a participant 102 of the blockchain system 160. In some arrangements, the access publishing circuit 152 is structured to generate a cross-reference link between an existing PIR blockchain 121 for a participant 102 and a newly formed PIR blockchain 121 of the newly registered participant 102 (e.g., formerly non-participant 104) of the system 160.

The access revocation circuit 156 is structured to organize and publish the information related to the revocations of approvals to the PIR blockchain 121 of the PIR blockchain system 160. For example, revocation information may indicate that an approval for a participant 102 has been revoked. The access revocation circuit 156 publishes a block to the PIR blockchain 121 and/or transaction blockchain 123 indicating the approval that has been revoked.

The access revocation circuit 156 may implement a variety of publishing mechanisms depending on the desired schema of the PIR system. In some arrangements, the access revocation circuit 156 can catalog revocations as they occur and then encrypt and publish the revocations to the PIR blockchain 121 and/or transaction blockchain 123 after a period of time (e.g., every hour, every day, etc.). In other arrangements, the access revocation circuit 136 can publish revocations to the blockchain system 160 in real-time as they occur. In some embodiments, the access revocation circuit 136 can publish revocations directly to the PIR blockchain 121, or on a parallel or shadow blockchain to the PIR blockchain 121 (e.g., transaction blockchain 123) linking the revocation information with the transaction information of each trade partnership the participant 102 may be privy to. In some embodiments, the access revocation circuit 156 is structured to create an associated transaction blockchain 123 for each participant 102 of a PIR blockchain 121 that has been revoked access.

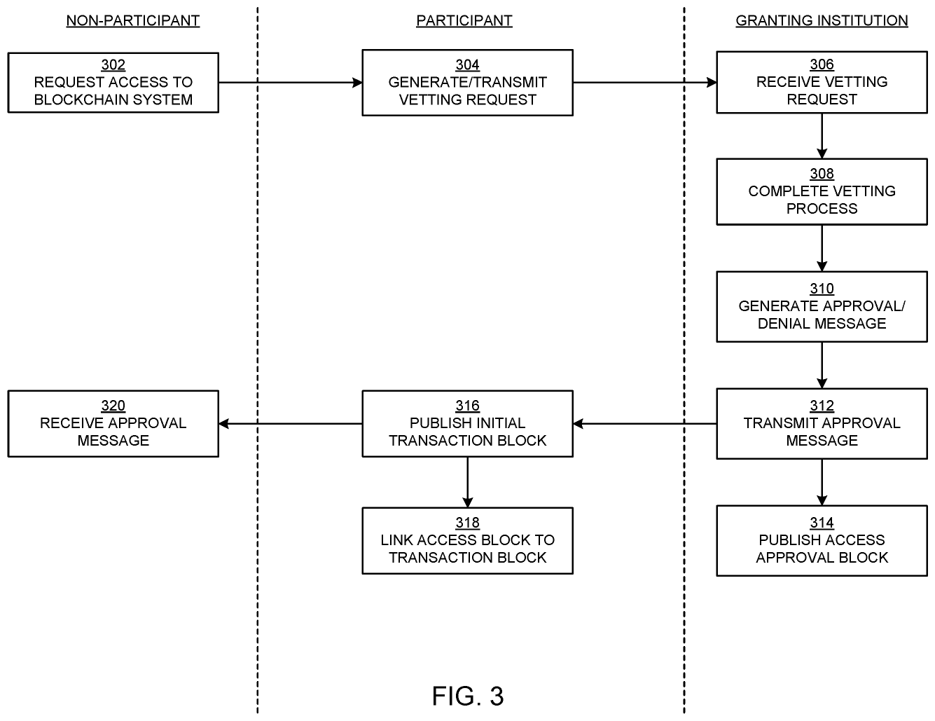

Referring now to FIG. 3, a flow diagram of interactions between a participant 102, a non-participant 104, and a granting institution 112, including use of the PIR blockchain system 160 is shown, according to an example embodiment. First, at 302, a non-participant 104 sends a message including a request for access to the participant 102 (e.g., received and processed by the participant computing system 106). At 304, the participant 102 generates a vetting request and transmits the request to the granting institution 112. In some embodiments, the vetting request includes a message to the granting institution 112 that the access has been requested by a non-participant 104 and was not due to an offer to share initiated by the participant 102. This message can be utilized by the granting institution 112, as described further herein at 314, to determine when an access block should be published to the blockchain system 160. At 306, the granting institution 112 receives the vetting request and at 308, proceeds to complete identity verification and vetting of the non-participant 104 via the identity verification circuit 128.

At 310, upon approval or denial of the non-participant 104, the granting institution 112 generates an approval/denial message and at 312, sends the approval/denial message to the participant 102. In some embodiments, the approval/denial message is additionally sent to the non-participant 104. At 314, if the non-participant 104 was approved by the granting institution 112, the granting institution 112 then publishes an access approval block to the PIR blockchain 160 system (e.g., to the PIR blockchain 121). If, at 304, the vetting request includes a message indicating that the request for access was initiated by the non-participant 104, the granting institution 112 proceeds to publish the access approval block immediately upon approval of the non-participant 104. If the message indicates that the vetting request stems from an offer to share initiated by the participant 102, the granting institution 112 will wait for instructions from the non-participant 104 that the non-participant 104 desires to have access to the blockchain system 160 (e.g., via an offer acceptance). The access approval block may be the initial block published to the PIR blockchain 121, establishing a separate PIR blockchain 121 for the new participant 102. Simultaneous to the granting institution 112 publishing an access block for the new participant 102 to the PIR blockchain 121, at 316, the participant 102 publishes an initial transaction block to the transaction blockchain 123, thereby establishing the trade partner relationship between the participants 102 on the blockchain system 160. In other embodiments, the participant 102 may publish the initial transaction block after the access block has been published by the granting institution 112 (e.g., in instances where the vetting request was sent due to an offer share initiated by the participant 102). At 318, the blockchain system 160 establishes a link or association between the access block on the participant PIR blockchain 121 and the initial transaction block on the transaction blockchain 123, such that updates to the PIR blockchain 121 of each participant 102 may additionally be published on the transaction blockchain 123 (e.g., in a parallel or shadow blockchain). At 320, the non-participant 104 receives an approval message from the participant 102 and/or the granting institution 112 indicating access to the blockchain system 160. As shown in FIG. 3, the non-participant 104 may receive the approval message at the same time the participant 102 receives the approval message from the granting institution 112 (at 312). In other embodiments, the non-participant 104 may receive the approval message subsequent to the participant 102 receiving the approval message.

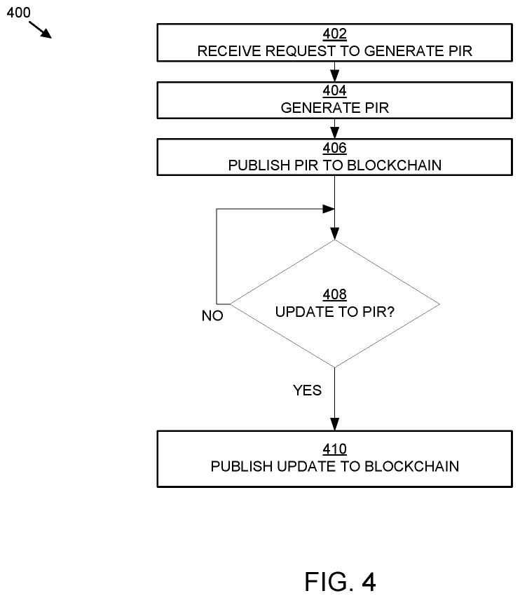

Referring now to FIG. 4, a method 400 of generating a PIR and updating the PIR via the PIR management system 100 is shown, according to an example embodiment. In describing method 400, references may be made to FIGS. 1-3.

At 402, a request to generate a PIR is received. The PIR request may include information relating to an identity of a participant 102, including but not limited to, a name, address, email, phone number, account numbers, routing numbers, tax exempt IDs, resale IDs, minority status, etc., of the participant 102. Prior to becoming a participant 102, the participant 102 (e.g., initially a non-participant 104) must have been registered and vetted as described above in regard to FIG. 3. As such, an access block would have already been published by the granting institution and hence, a PIR blockchain 121 established for the participant 102. In some arrangements, the PIR generation request is transmitted from PIR update circuit 132 of the participant computing system 106.

At 404, upon receiving the request, the PIR is generated. At 406, the PIR is published to the blockchain. More specifically, the PIR is published to the PIR blockchain 121 of the PIR blockchain system 160 as a subsequent block to the access block generated and published by the granting institution computing system 116. The PIR is accessible by other participants 102 that may engage in a trade partner relationship with the participant 102 to view PIR and PIR updates on the PIR blockchain system 160.

At 408, an update to the PIR is determined. The PIR update circuit 132 determines that an update to the PIR for a participant 102 has occurred. Alternatively, the participant 102 (and/or a participant 102 in a trade partnership with the participant 102) can determine that an update to a PIR has occurred and can communicate the update to the participant computing system 106 and/or the granting institution computing system 116 or can directly update the blockchain if update access is granted. The PIR update circuit 132 can additionally organize the information into restricted and unrestricted information.

At 410, the updated PIR is published to the blockchain. Upon finding an update to the PIR has occurred, the updated PIR is published to the PIR blockchain 121 by the PIR update circuit 132. In some arrangements, the PIR update circuit 132 can publish updated PIRs periodically (e.g., every hour, every day, etc.). In other arrangements, the PIR update circuit 136 can publish PIR updates to the PIR blockchain 121 in real-time as they occur. The policy information can be published on a separate second blockchain parallel to and associated with the PIR blockchain 121 (e.g., a parallel or shadow blockchain), or can be published on the PIR blockchain 121 in a subsequent block on the blockchain 121. In other embodiments, the PIR update circuit 132 can publish updates directly to the transaction blockchain 123, or as a parallel or shadow blockchain to the transaction blockchain 123 linking the PIR update information with the transaction occurring between participants 102.

The blockchain-based PIR management system solves technical problems associated with conventional data systems. Specifically, in current systems in instances where a PIR update has occurred, participants and third parties may unknowingly rely on outdated information in conducting transactions. For instance, when a PIR update is an update an address of a participant 102, goods may be shipped or payments may be sent to the wrong location. In conventional systems it may not be easily ascertainable when a PIR update occurs. In the instant system, participants 102 of the system would no longer be relying on outdated information because information regarding the updates to PIRs is readily accessible via blockchain. The instant blockchain-based system utilizes updates to PIRs to inform participants of updates to important trade partner information. In this way, the instant blockchain-based system preserves the history of updates to PIRs and additionally allows tracing of access to the blockchain system. Unlike current systems in which trade partner information may be simply replaced once updated, the instant blockchain-based system publishes updates to PIRs in a new block without deleting information related to any prior information. Thus, tracking PIR updates via the instant blockchain-based system can make trade partner transactions more accurate, efficient, and secure. Furthermore, having the most recent update to a PIR may mean having the most recent tax ID, tax exempt status, minority status, etc., for tax purposes. As such, when auditing of the trade partner relationship occurs, the most recent information and any update history are readily available.

The embodiments described herein have been described with reference to drawings. The drawings illustrate certain details of specific embodiments that implement the systems, methods and programs described herein. However, describing the embodiments with drawings should not be construed as imposing on the disclosure any limitations that may be present in the drawings.

It should be understood that no claim element herein is to be construed under the provisions of 35 U.S.C. § 112(f), unless the element is expressly recited using the phrase “means for.”

As used herein, the term “circuit” may include hardware structured to execute the functions described herein. In some embodiments, each respective “circuit” may include machine-readable media for configuring the hardware to execute the functions described herein. The circuit may be embodied as one or more circuitry components including, but not limited to, processing circuitry, network interfaces, peripheral devices, input devices, output devices, sensors, etc. In some embodiments, a circuit may take the form of one or more analog circuits, electronic circuits (e.g., integrated circuits (IC), discrete circuits, system on a chip (SOCs) circuits, etc.), telecommunication circuits, hybrid circuits, and any other type of “circuit.” In this regard, the “circuit” may include any type of component for accomplishing or facilitating achievement of the operations described herein. For example, a circuit as described herein may include one or more transistors, logic gates (e.g., NAND, AND, NOR, OR, XOR, NOT, XNOR, etc.), resistors, multiplexers, registers, capacitors, inductors, diodes, wiring, and so on).

The “circuit” may also include one or more processors communicably coupled to one or more memory or memory devices. In this regard, the one or more processors may execute instructions stored in the memory or may execute instructions otherwise accessible to the one or more processors. In some embodiments, the one or more processors may be embodied in various ways. The one or more processors may be constructed in a manner sufficient to perform at least the operations described herein. In some embodiments, the one or more processors may be shared by multiple circuits (e.g., circuit A and circuit B may comprise or otherwise share the same processor which, in some example embodiments, may execute instructions stored, or otherwise accessed, via different areas of memory). Alternatively or additionally, the one or more processors may be structured to perform or otherwise execute certain operations independent of one or more co-processors. In other example embodiments, two or more processors may be coupled via a bus to enable independent, parallel, pipelined, or multi-threaded instruction execution. Each processor may be implemented as one or more general-purpose processors, application specific integrated circuits (ASICs), field programmable gate arrays (FPGAs), digital signal processors (DSPs), or other suitable electronic data processing components structured to execute instructions provided by memory. The one or more processors may take the form of a single core processor, multi-core processor (e.g., a dual core processor, triple core processor, quad core processor, etc.), microprocessor, etc. In some embodiments, the one or more processors may be external to the apparatus, for example the one or more processors may be a remote processor (e.g., a cloud based processor). Alternatively, or additionally, the one or more processors may be internal and/or local to the apparatus. In this regard, a given circuit or components thereof may be disposed locally (e.g., as part of a local server, a local computing system, etc.) or remotely (e.g., as part of a remote server such as a cloud based server). To that end, a “circuit” as described herein may include components that are distributed across one or more locations.

An exemplary system for implementing the overall system or portions of the embodiments might include a general purpose computing computers in the form of computers, including a processing unit, a system memory, and a system bus that couples various system components including the system memory to the processing unit. Each memory device may include non-transient volatile storage media, non-volatile storage media, non-transitory storage media (e.g., one or more volatile and/or non-volatile memories), etc. In some embodiments, the non-volatile media may take the form of ROM, flash memory (e.g., flash memory such as NAND, 3D NAND, NOR, 3D NOR, etc.), EEPROM, MRAM, magnetic storage, hard discs, optical discs, etc. In other embodiments, the volatile storage media may take the form of RAM, TRAM, ZRAM, etc. Combinations of the above are also included within the scope of machine-readable media. In this regard, machine-executable instructions comprise, for example, instructions and data which cause a general purpose computer, special purpose computer, or special purpose processing machines to perform a certain function or group of functions. Each respective memory device may be operable to maintain or otherwise store information relating to the operations performed by one or more associated circuits, including processor instructions and related data (e.g., database components, object code components, script components, etc.), in accordance with the example embodiments described herein.

It should also be noted that the term “input devices,” as described herein, may include any type of input device including, but not limited to, a keyboard, a keypad, a mouse, joystick or other input devices performing a similar function. Comparatively, the term “output device,” as described herein, may include any type of output device including, but not limited to, a computer monitor, printer, facsimile machine, or other output devices performing a similar function.

Any foregoing references to currency or funds are intended to include fiat currencies, non-fiat currencies (e.g., precious metals), and math-based currencies (often referred to as cryptocurrencies). Examples of math-based currencies include Bitcoin, Litecoin, Dogecoin, and the like.

It should be noted that although the diagrams herein may show a specific order and composition of method steps, it is understood that the order of these steps may differ from what is depicted. For example, two or more steps may be performed concurrently or with partial concurrence. Also, some method steps that are performed as discrete steps may be combined, steps being performed as a combined step may be separated into discrete steps, the sequence of certain processes may be reversed or otherwise varied, and the nature or number of discrete processes may be altered or varied. The order or sequence of any element or apparatus may be varied or substituted according to alternative embodiments. Accordingly, all such modifications are intended to be included within the scope of the present disclosure as defined in the appended claims. Such variations will depend on the machine-readable media and hardware systems chosen and on designer choice. It is understood that all such variations are within the scope of the disclosure. Likewise, software and web implementations of the present disclosure could be accomplished with standard programming techniques with rule based logic and other logic to accomplish the various database searching steps, correlation steps, comparison steps and decision steps.

The foregoing description of embodiments has been presented for purposes of illustration and description. It is not intended to be exhaustive or to limit the disclosure to the precise form disclosed, and modifications and variations are possible in light of the above teachings or may be acquired from this disclosure. The embodiments were chosen and described in order to explain the principals of the disclosure and its practical application to enable one skilled in the art to utilize the various embodiments and with various modifications as are suited to the particular use contemplated. Other substitutions, modifications, changes and omissions may be made in the design, operating conditions and arrangement of the embodiments without departing from the scope of the present disclosure as expressed in the appended claims.

1. A method comprising:
receiving, by one or more processors of a participant computing system, a participant information record (PIR) generation request from a first participant via a participant computing device, the PIR generation request including a participant identity;
generating, by the one or more processors, a PIR block for the first participant based on the PIR generation request;
storing, by the one or more processors, the PIR block to a PIR blockchain,
receiving, by the one or more processors, an access request of a non-participant computing system that is not approved to access the PIR blockchain;
generating, by the one or more processors, responsive to the access request, a vetting request of the non-participant computing system, the vetting request including a non-participant computing system identity;
transmitting, by the one or more processors, the vetting request to a granting institution computing system;
identifying, by the one or more processors, an access approval block published by the granting institution computing system in response to approval of the access request for the non-participant computing system;
storing, by the one or more processors, the access approval block to the PIR blockchain;
storing, by the one or more processors, a transaction block to the PIR blockchain simultaneous to storing the access approval block to establish access rights to the PIR blockchain by the non-participant computing system;
receiving, by the one or more processors, from the non-participant computing system subsequent to storing the transaction block, a PIR update;
generating, by the one or more processors, a PIR update block based on the PIR update;
identifying, by the one or more processors, from the PIR update, a reference identifier of the non-participant computing system;
generating, by the one or more processors, a link between the PIR update block and the PIR blockchain responsive to cross-referencing the reference identifier of the non-participant computing system with a reference identifier of the first participant; and
storing, by the one or more processors, based on the link, the PIR update block to the PIR blockchain to reflect a change in the PIR block, wherein the PIR update block is stored as a new block to the PIR blockchain, and wherein the PIR block, the PIR update block, and any subsequently stored PIR update blocks are all viewable together on the PIR blockchain.

2. (canceled)

3. (canceled)

4. The method of claim 1, wherein the access approval block indicates a time and date of the approval for access for the non-participant computing system.

5. The method of claim 1, further comprising:
generating, by the one or more processors, an offer to share message, wherein the offer to share message includes the participant identity and a transaction identifier; and
transmitting, by the one or more processors, the offer to share message, to non-participant computing system.

6. The method of claim 5, further comprising:
receiving, by the one or more processors, an offer approval to share message, from the non-participant computing system.

7. The method of claim 6, further comprising:
receiving, by the one or more processors, the approval for access from the granting institution computing system.

8. The method of claim 1, wherein the access approval block indicates a time and date of the approval for access for the non-participant computing system.

9. The method of claim 1, further comprising:
generating, by the one or more processors, a revocation of access block in response to receiving a revocation of access of the first participant to the PIR blockchain;
storing, by the one or more processors, the revocation of access block to the PIR blockchain to reflect the revocation of access; and
monitoring, by the one or more processors, for the revocation of access of the first participant.

10. The method of claim 1, wherein the PIR update is subsequent to a block containing the PIR.

11. The method of claim 1, further comprising:
generating, by the one or more processors, transaction information, wherein the transaction information relates to a transaction between two or more participants of a PIR blockchain;
storing, by the one or more processors, the transaction information to a transaction blockchain managed by the PIR blockchain;
determining, by the one or more processors, a transaction information update; and
storing, by the one or more processors, the transaction information update to the transaction blockchain to reflect a change in the transaction.

12. The method of claim 1, further comprising:
storing, by the one or more processors, a uniform resource identifier (URI) comprising a uniform resource locator (URL) from which underlying data is retrieved.

13. A PIR management system comprising:
a network interface configured to facilitate data transmission over a network; and
a circuit configured to:
generate a PIR block for a first participant of a PIR blockchain;
store the PIR block to a PIR blockchain, wherein the PIR blockchain is managed by the PIR blockchain;
receive an access request of a non-participant computing system that is not approved to access the PIR blockchain;
generate, responsive to the access request, a vetting request of the non-participant computing system, the vetting request including a non-participant computing system identity;
transmit, the vetting request to a granting institution computing system;
identify an access approval block published by the granting institution computing system in response to approval of access for a non-participant computing system;
store the access approval block to the PIR blockchain;
store a transaction block to the PIR blockchain simultaneous to storing the access approval block to establish access rights to the PIR blockchain by the non-participant computing system;
receive, from the non-participant computing system subsequent to storing the transaction block, a PIR update;
generate a PIR update block based on the PIR update;
identify, from the PIR update, a reference identifier of the non-participant computing system;
generate a link between the PIR update block and the PIR blockchain responsive to cross-referencing the reference identifier of the non-participant computing system with a reference identifier of the first participant; and
store, based on the link, the PIR update block to the PIR blockchain to reflect a change in the PIR block, wherein the PIR update block is stored as a new block in the PIR blockchain, and wherein the PIR block, the PIR update block, and any subsequently stored PIR update blocks are all viewable together on the PIR blockchain.

14. The system of claim 13, wherein the PIR update block is subsequent to the PIR block.

15. (canceled)

16. The system of claim 15, further comprising:
receive the approval for access from the granting institution computing system.

17. The system of claim 13, wherein the access approval block indicates a time and date of the approval for access for the non-participant computing system.

18. The system of claim 13, further comprising:
generate an offer to share message, wherein the offer to share message includes an identity of the first participant and a transaction identifier;
transmit the offer to share message, to non-participant computing system; and
receive an offer approval to share message from the non-participant computing system.

19. (canceled)

20. (canceled)

21. The system of claim 13, further comprising:
generate transaction information, wherein the transaction information relates to a transaction between two or more participants of the PIR blockchain;
store the transaction information to a transaction blockchain managed by the PIR blockchain;
determine a transaction information update; and
store the transaction information update to the transaction blockchain to reflect a change in the transaction.

22. The system of claim 13, wherein the PIR update circuit is further configured to store a uniform resource identifier (URI) comprising a uniform resource locator (URL) from which underlying data is retrieved.
